(19) United States
(12) Patent Application Publication
(10) Pub. No.: US 2013/0162069 A1
(43) Pub. Date: Jun. 27, 2013

(54) CAPACITOR-OPERATED MOTOR HAVING A SINGLE WINDING SPAN

(71) Applicant: CHANG Fang-Fu, Taipei City (TW)

(72) Inventor: CHANG Fang-Fu, Taipei City (TW)

(21) Appl. No.: 13/343,646

(22) Filed: Jan. 4, 2012

(30) Foreign Application Priority Data
Dec. 21, 2011 (TW) 100147821

(51) Int. Cl. H02K 5/24

(52) U.S. Cl. 310/51

(57) ABSTRACT

A capacitor-operated motor having a single winding span includes a housing, a stator par, and a rotor par. The stator part is formed by stacking up a plurality of stator core plates that have a plurality of primary-phase tooth parts, secondary-phase tooth parts, and stator slots. The primary windings and the secondary windings are wound around the primary-phase tooth parts and the secondary-phase tooth parts respectively. When the current is conducted through the plurality of primary windings and the plurality of secondary windings, magnetic force is generated to rotate the rotor part. The secondary-phase tooth parts are alternately arranged with the primary-phase tooth parts with stator slot positioned in between them. The fact that the number of rotor slot is at least two times as many as that of the stator slot is capable of lowering the vibration and noise of the capacitor-operated motor having a single winding span.

### BACKGROUND OF THE INVENTION

1. Field of the Invention

The invention relates to a capacitor-operated motor having a single winding span, and more particularly, to a capacitor-operated motor having a single winding span that the number of rotor slot is two times as many of that of the stator slot and the motor has a single stator slot winding span.

2. Description of the Prior Art

Motor is widely applied in various industries, people's livelihood, transportation, and information facilities such as industrial robot, semiconductor manufacturing facilities, the automatic assembling facilities of PCB device, elevator, air condition, electric train of MRT, motorcycle, image scanner, laser printer, and CD-ROM driver etc. Due to the widely market requirement, motor has become an indispensable fundamental element in a progressive society nowadays, and various design, manufacturing, and control techniques of motor are in a rapid developing period.

In general, power source in the market provides both single-phase and three-phase alternate current. The three-phase motor possesses starting torque since its three-phase power source generates rotating magnetic field. The average family uses single-phase motor with alternate current since they uses single-phase power source. The single-phase motor does not possess starting torque as it is unable to generate rotating magnetic field. In order to let the single-phase motor possess starting torque, the following measure is taken to generate rotating magnetic field. First of all, in the stator structure of a single-phase motor, a primary winding and an auxiliary winding are furnished to generate a magnetic field that forms a fixed 90° angle in the space. The primary winding and the auxiliary winding are in parallel on the circuit, and the magnitude and phase angle of the current are all different, thereby, the peak value and the magnitude of the magnetic field are all different in the primary winding and the auxiliary winding since the impedance connected are not the same, and the total magnetic field is the sum of both of them. The impedance is adjusted in accordance with different capacitor as the characteristic of a capacitor is that if the current and the voltage lead, the lag of the phase angle is capable of being offset for improving the use of the electrical quality. Then, the vector sum of both that are fixed 90 ° angle in the space is capable of forming a rotating magnetic field to make the single-phase motor possesses starting torque.

FIG. 1 is an elevation view showing the structure of the stator part of the capacitor-operated motor of the prior art while FIG. 2 is an elevation view showing the structure of the core plate of the rotor of the capacitor-operated motor of the prior art. As shown in FIG. 1 and FIG. 2, the stator part (9) of the capacitor-operated motor of the prior art includes a plurality of stator core plates (91) and a plurality of windings (90). Each of the stator core plate (91) being made of stamping silicon steel plate has a plurality of salient bodies (911) and a plurality of stator slots (912) alternately arranged in ring shape. The winding (90) is wound around three or more than three salient bodies (911) in the way that the winding spans across two or more than two stator slots (912), that is, the number of winding span is two or more than two. Moreover, the windings (90) are alternately stacked up to form a primary winding (92) having relatively fewer coil number and a secondary winding (93) having relatively more coil number.

The rotor part (8) of the capacitor-operated motor of the prior art being positioned in the stator part (9) is corresponding to the stator part (9). Moreover, the rotor part (8) being made of silicon steel plates is formed by stacking up a plurality of rotor core plates (81). What is more, there is a plurality of rotor slots (82) on the rotor core plate (81). The number of the rotor slot (82) is designed to be closed to the number of the stator slot (912). A rule of thumb of the number of stator slot (912) is “fewer slot and closed number of slot”.

As the cost of steel material is getting higher and higher, accordingly, the manufacturing cost of capacitor-operated motor is getting higher. Therefore, just how to resolve the above-mentioned problems becomes necessary in the industry to improve the design of the capacitor-operated motor of the prior art.

### SUMMARY OF THE INVENTION

In light of the above-mentioned disadvantages of the prior art, the invention provides “capacitor-operated motor having a single winding span ” that is capable of overcoming the shortcomings of the prior art, satisfying the requirements of the industry, as well as improving the competitiveness in the market. It aims to ameliorate at least some of the disadvantages of the prior art or to provide a useful alternative.

The primary objective of the invention is to provide “capacitor-operated motor having a single winding span ” and by the use of making the number of winding span of the stator as one to accommodate the design that the number of rotor slot (311) is at least two times as that of the stator slot (213), one can achieve the efficacies of lowering the vibration and noise of the capacitor-operated motor of the invention.

To achieve the above-mentioned objectives, the invention provides a capacitor-operated motor having a single winding span includes a housing (1), a stator part (2), and a rotor part (3). The stator part (2) is formed by stacking up a plurality of stator core plates (21) that have a plurality of primary-phase tooth parts (211), secondary-phase tooth parts (212), and stator slots (912). The primary windings (22) and the secondary windings (23) are wound around the primary-phase tooth parts (211) and the secondary-phase tooth parts (212) respectively. The rotor part (3) being correspondent with the stator part (2) has a plurality of rotor slots (311) arranged in ring shape. When the current is conducted through the plurality of primary windings (22) and the plurality of secondary windings (23), magnetic force is generated to rotate the rotor part (3). The secondary-phase tooth parts (212) are alternately arranged with the primary-phase tooth parts (211) with stator slot (213) positioned in between them. That the number of rotor slot (311) is at least two times as many as that of the stator slot (213) is capable of lowering the vibration and noise of the capacitor-operated motor having a single winding span.

The accomplishment of the above-mentioned objectives of the invention will become apparent from the following description and its accompanying drawings of which:

### BRIEF DESCRIPTION OF THE DRAWINGS

FIG. 1 is an elevation view showing the structure of the stator part of the capacitor-operated motor of the prior art;

FIG. 2 is an elevation view showing the structure of the core plate of the rotor of the capacitor-operated motor of the prior art;

FIG. 3 is an isometric exploded view of the capacitor-operated motor having a single winding span of a preferred embodiment of the invention;

FIG. 4 is an elevation view showing the structure of the stator part of the capacitor-operated motor of the invention;

FIG. 5 is an isometric exploded view of the rotor part of the capacitor-operated motor having a single winding span of the invention;

FIG. 6 is an isometric exploded view of the rotor slot number and stator slot number of a single-phase 4-pole capacitor-operated motor having a single winding span of a preferred embodiment of the invention; and

FIG. 7 is an isometric exploded view of the rotor slot number and stator slot number of a single-phase 2-pole capacitor-operated motor having a single winding span of a preferred embodiment of the invention.

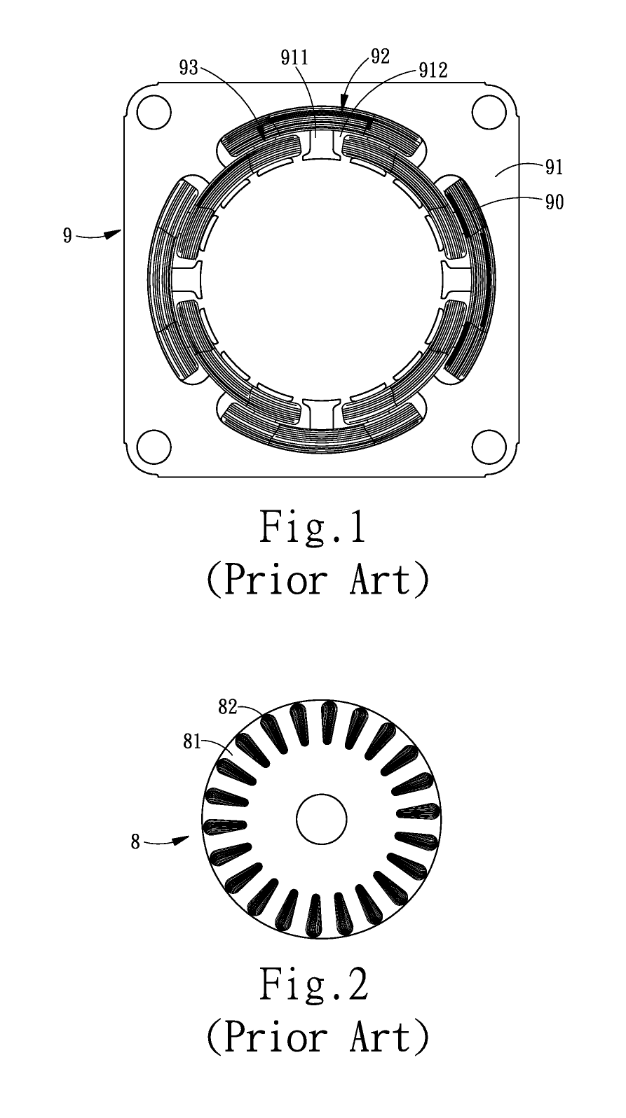

### DETAILED DESCRIPTION OF THE PREFERRED EMBODIMENT

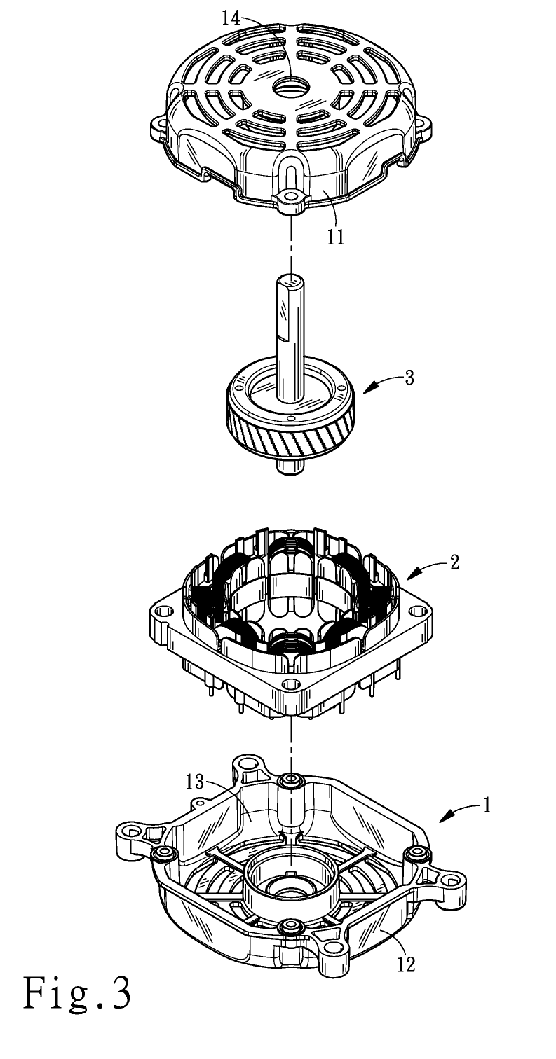

FIG. 3 is an isometric exploded view of the capacitor-operated motor having a single winding span of a preferred embodiment of the invention.

As shown in FIG. 3, the capacitor-operated motor having a single winding span of the invention includes a housing (1), a stator part (2), and a rotor part (3). The housing (1) being a hollow structure and having a containing space (13) and a penetrating hole (14) is formed by connecting an upper cover (11) and a corresponding lower cover (12) where the penetrating hole (14) is positioned and penetrating through the upper cover (11).

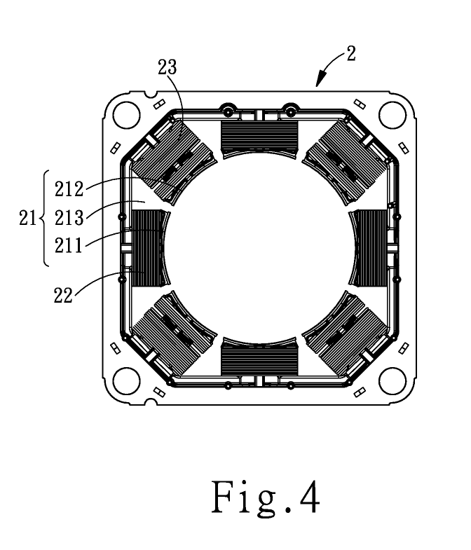

FIG. 4 is an elevation view showing the structure of the stator part of the capacitor-operated motor of the invention. As shown in FIG. 4, the stator part (2) being contained in the containing space (13) of the housing (1) includes a plurality of stator core plates (21), a plurality of primary windings (22), and a plurality of secondary windings (23). The stator core plate (21) is made of stamping silicon steel plate. The stator part (2) is formed by having a plurality of primary windings (22) and a plurality of secondary windings (23) wound around the body formed by stacking up the plurality of stator core plates (21). Each of the stator core plate (21) includes a plurality of primary-phase tooth parts (211), a plurality of secondary-phase tooth parts (212), and a plurality of stator slot (213) to form a ring-shape arrangement having the primary-phase tooth parts (211) alternating with the secondary-phase tooth parts (212) with the stator slot (213) positioned in between the primary-phase tooth parts (211) and secondary-phase tooth parts (212).

As shown again in FIG. 4, the plurality of primary windings (22) being wound around the stacked-up primary-phase tooth parts (211) are one-to-one corresponding to the plurality of primary-phase tooth parts (211) while the plurality of secondary windings (23) being wound around the stacked-up secondary-phase tooth parts (212) are one-to-one corresponding to the plurality of secondary-phase tooth parts (212).

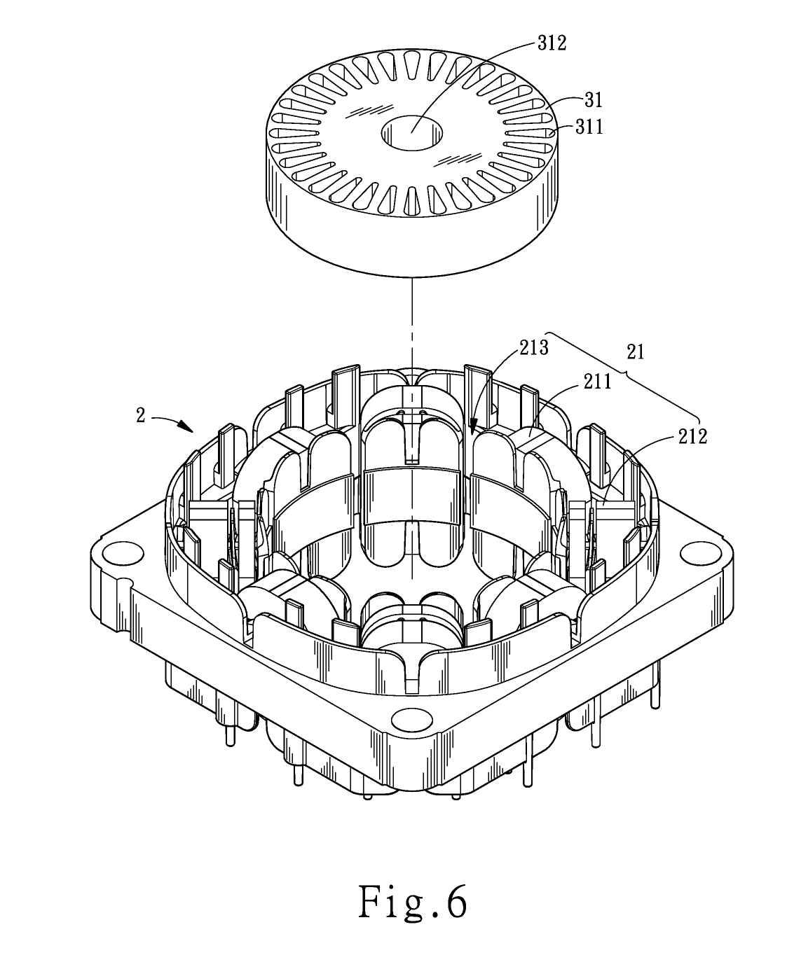

FIG. 6 is an isometric exploded view of the rotor slot number and stator slot number of a single-phase 4-pole capacitor-operated motor having a single winding span of a preferred embodiment of the invention. As shown in FIG. 6, in the single-phase 4-pole capacitor-operated motor having a single winding span of a preferred embodiment of the invention, the stator slot (213) has 8 slots with 4 slots in the primary-phase tooth parts (211) and 4 slots in secondary-phase tooth parts (212) respectively. It is understood that it is not necessary to repeat that the variation of this kind of number can be made to the structure of the invention without departing from the scope or spirit of the invention.

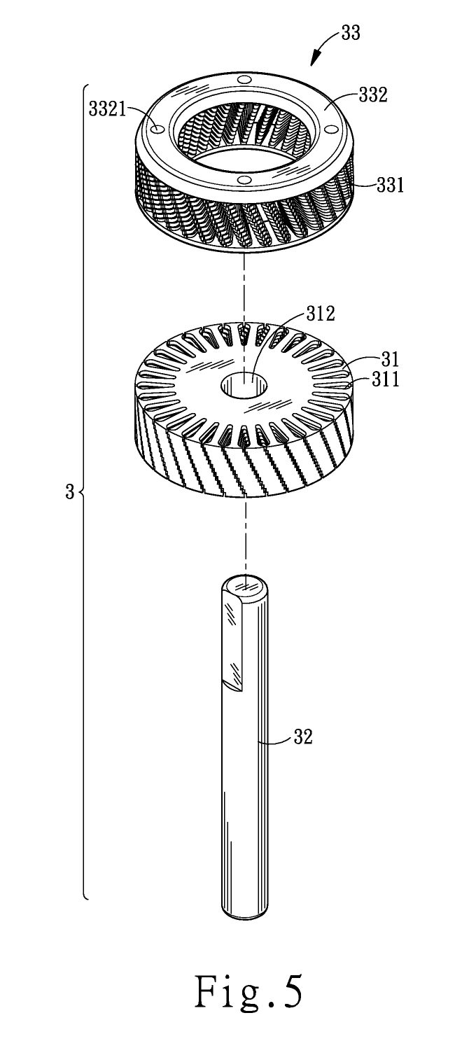

FIG. 5 is an isometric exploded view of the rotor part of the capacitor-operated motor having a single winding span of the invention.

As shown in FIG. 5, the rotor part (3) being correspondent with and positioned in the stator part (2) includes a plurality of rotor core plates (31), a spindle (32), and a squirrel-cage winding (33) consisted of a plurality of arranged conductor strips (331). The plurality of rotor core plates (31) being made of stamping silicon steel plate and connected together by stacking up has a plurality of rotor slots (311) arranged in ring-shape and an opening (312). The spindle (32) being positioned in the opening (312) is connected to the rotor core plates (31) and is passed through the penetrating hole (14) and extended out the housing (1). The plurality of conductor strips (331) consisted of arranged strips are clipped between an upper and lower short-circuit rings (332). A number of penetrating filling holes (3321) are provided in the short-circuit rings (332) that is capable of filling melting liquid aluminum to combine with the spindle (32). Since the capacitor-operated motor having a single winding span of the invention is an induction motor, the design of the motor is that when the current is conducted through the plurality of primary windings (22) and the secondary windings (23) making the primary-phase tooth parts (211) and the secondary-phase tooth parts (212) generate magnetic force, one is not only capable of utilizing the phase variation of alternate current to generate the changing magnetic field but also capable of utilizing the changing surrounding magnetic field to induce the central rotor part (3) for generating magnetic field. In this way, since no winding coil is necessary in the rotor part (3), the structure of the rotor part (3) can be simplified. Moreover, the squirrel-cage winding (33) externally designed as induction motor (single-phase and three-phase) by utilizing the short circuit effect by use of the conductor strips (331) clipped by the upper and lower short-circuit rings (332), and having the spindle (32) inserted through the stacked-up rotor core plates (31) is capable of generating eddy current and magnetic force through the induction of the varying magnetic field, to make the rotor part (3) rotate.

Since the winding coils of both the primary windings (22) and the secondary windings (23) are made of copper wire, the design of the prior art with the number of winding span more than 2 needs to use a lot of copper wire, thereby, makes the manufacturing cost very high, especially the copper price of raw material is soaring high nowadays. Therefore, the “capacitor-operated motor having a single winding span” of the invention having the number of winding span designed as 1 is capable of saving the use of copper material. Although the design of invention generates relatively higher vibration and noise, the problems can be resolved by having the number of rotor slot (311) designed as twice as many as the number of stator slot (213).

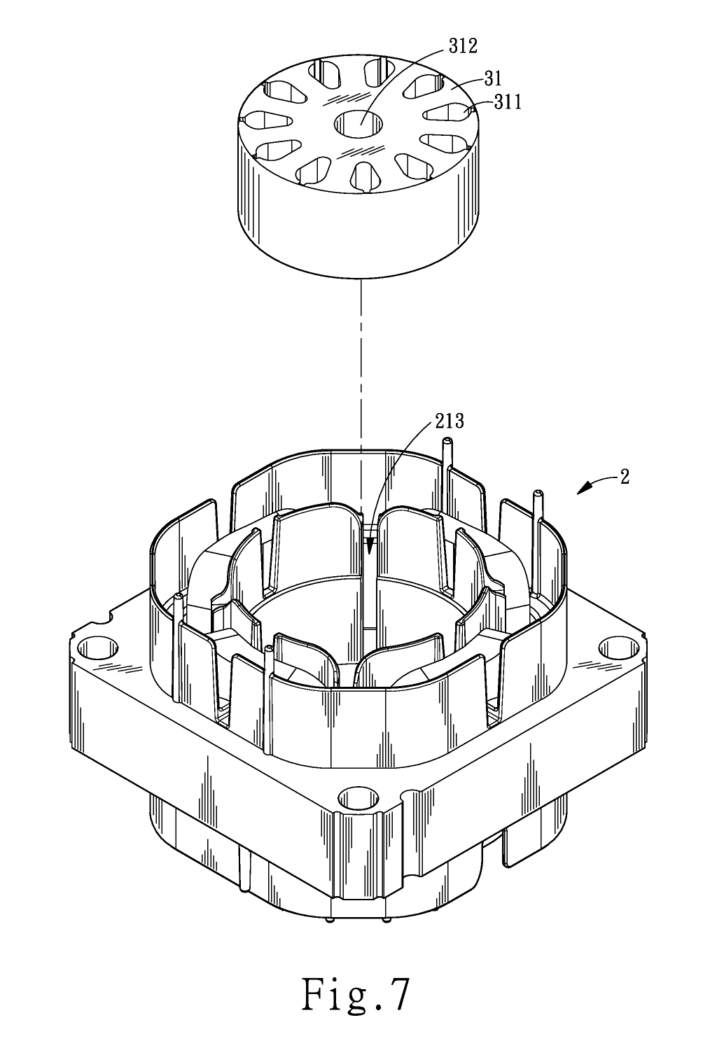

FIG. 6 and FIG. 7 are isometric exploded views of the rotor slot number and stator slot number of a single-phase 4-pole and 2-pole respectively capacitor-operated motor having a single winding span of a preferred embodiment of the invention. As shown in FIG. 6 and FIG. 7, in the single-phase 4-pole capacitor-operated motor having a single winding span of a preferred embodiment of the invention, the stator slot (213) having 8 slots is capable of lowering the vibration of the conductor strips (331) at both the fixed end and the free end, and the vibration of the whole capacitor-operated motor is lowered accordingly. In the single-phase 2-pole capacitor-operated motor having a single winding span of a preferred embodiment of the invention, the rotor slot (311) having 11 slots and the stator slot (213) having 4 slots is also capable of lowering the noise and the vibration.

Therefore, the “capacitor-operated motor having a single winding span” of the invention is capable of overcoming the shortcomings of the prior art, satisfying the requirements of the industry, as well as improving the competitiveness in the market.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A capacitor-operated motor having a single winding span, comprising:
a housing;
a stator part positioned in the housing, further comprising:
a plurality of stator core plates stacking up together, each of them further comprising a plurality of primary-phase tooth parts, a plurality of secondary-phase tooth parts, and a plurality of stator slots;
a plurality of primary windings being one-to-one correspondent to a plurality of primary-phase tooth parts are wound around the stacked-up primary-phase tooth parts;
a plurality of secondary windings being one-to-one corresponding a plurality of secondary-phase tooth parts are wound around the stacked-up secondary-phase tooth parts; and
a rotor part corresponding to and positioning in the stator part, and having a plurality of rotor slots arranged in ring-shape;
wherein, when the current is conducted through the plurality of primary windings and the plurality of secondary windings, the primary-phase tooth parts and the secondary-phase tooth parts are capable of generating magnetic force to make the rotor part rotate; the secondary-phase tooth parts are alternated with the primary-phase tooth parts and are arranged in ring-shape while the stator slots are positioned in between them, and the number of rotor slots are at least two times as many as the stator slots.

2. The capacitor-operated motor having a single winding span as claimed in claim 1, wherein a single-phase 4-pole motor is formed, the number of rotor slot is 32, and the number of stator slot is 8.

3. The capacitor-operated motor having a single winding span as claimed in claim 1, wherein a single-phase 2-pole motor is formed, the number of rotor slot is 11, and the number of stator slot is 4.

4. The capacitor-operated motor having a single winding span as claimed in claim 1, wherein the stator core plate is made of stamping silicon steel plate.

5. The capacitor-operated motor having a single winding span as claimed in claim 1, wherein the rotor part is made of a plurality of stacked-up stamping silicon steel plates.
